(19) United States
(12) Patent Application Publication
(10) Pub. No.: US 2007/0041690 A1
(43) Pub. Date: Feb. 22, 2007

(54) Waveguide structure having ladder configuration

(75) Inventors: Yen-Siang Wu, Tainan City (TW); Wei-Yu Chiu, Yanshuei Township (TW); Jin-Wei Shi, Taipei (TW)

Correspondence Address: TROXELL LAW OFFICE PLLC;SUITE 1404, 5205 LEESBURG PIKE, FALLS CHURCH, VA, 22041, US

(73) Assignee: National Central University

(21) Appl. No.: 11/377,303

(22) Filed: Mar. 17, 2006

(30) Foreign Application Priority Data
Aug. 22, 2005 (TW) 094128654

(51) Int. Cl. G02B 6/10

(52) U.S. Cl. 385/129; 385/14

(57) ABSTRACT

A waveguide structure is formed in the present invention. With the structure, a yield of a cleaving process is improved. A high responsivity and a low sensitivity can be achieved. And an error tolerance for a production is also increased. The present invention can be applied to optoelectronic elements, such as an optical diode and a light modulator.

### FIELD OF THE INVENTION

The present invention relates to a waveguide structure; more particularly relates to diminishing a scattering of optical power, increasing an alignment tolerance for a production, lessening a polarization sensitivity, and improving a yield of a cleaving process.

### DESCRIPTION OF THE RELATED ARTS

A prior art is revealed in a U.S. Pat. No. 6,483,863, “A symmetric waveguide electro-absorption-modulated laser”, which is an adjustable laser device with more than two stacked layers of asymmetric optical waveguides. An optical waveguide layer of the laser device is a growth region to enhance a first optical mode; and, the other optical waveguide layer connected with the previous optical waveguide layer is a modulator having a second optical mode with an effective refractive index different from that of the first optical mode. A light is transmitted from the previous optical waveguide layer through a cone at a side.

Please refer to FIG. 8, general waveguide structures used in gradual-coupling side-illuminating photo detectors may be divided into two categories. One category is an asymmetric twin waveguide (ATG) having two layers. The bottom layer in the waveguide structure of the ATG is a layer of an optical fiber waveguide 19 for collecting optical power. The top layer is a layer of an optical coupling waveguide 20 for shifting the position of the optical power. In order to obtain the same responsivities for the two optical modes, not only a special design is done to the refractive index of the epitaxy layer; but also a geometric cone-shaped structure is used for defining to increase light absorbing are a and to effectively absorb optical power with a small area of an absorbing layer. However, a waveguide structure having two cone-shaped layer is hard to be fabricated because it is difficult to align the two layers of optical waveguides; and, a great scattering loss to the optical power occurs during its transmission in the cone-shaped structure. Please refer to FIG. 9, which is a view of a refractive index curve for various epitaxy layer thicknesses, including an epitaxy layer thickness for an optical fiber waveguide 21 and that for an optical coupling waveguide 22. Please refer to FIG. 10, which is a view of distributions of optical power simulated by using a beam propagation method (BPM). Regarding the distribution of total optical power 23, twenty percent of power loses at the first 500 μm in the front although with a good exchanging rate between the energy distribution of the optical fiber waveguide 24 and the energy distribution of the optical coupling waveguide 25 under a prerequisite of two precisely aligned optical waveguides; and, an energy distribution of an absorbing layer 26 is included. The length of the optical fiber waveguide 27 is 100 μm; the length of the optical coupling waveguide 28 is 400 μm; and, the waveguide length for the absorbing layer 29 is 50 μm.

However, another category of a waveguide structure of a short planar multimode waveguide (SPMG) is revealed. Please refer to FIG. 11, which is a sectional view of a second prior art of SPMG, which comprises a substrate 30, an undoped optical waveguide layer 31, a first N-doped optical matching layer 32, a second N-doped optical matching layer 33, an absorbing layer 34 and a P-doped layer 35. An optical fiber waveguide and an optical coupling waveguide are combined with an epitaxy structure; and, through a design of a very short distance for the oscillation cycle of optical power, the scattering of the optical power is reduced and the difficulties for a production is diminished. However, because the shape of the optical waveguide is not defined through etching, several adjustable factors are omitted in a design and so difficulties are increased on considering both of the responsivity and the polarization sensitivity. Thereby, the precision of the cleaving during its process strongly affects its responsivity. Please refer to FIG. 12 and FIG. 13, which are views of the distributions of optical power under a TE mode and a TM mode, comprising curves of total energy distributions 36a,36b and curves of energy distributions of optical fiber waveguides 37a,37b, optical coupling waveguides 38a,38b and waveguides for absorbing layers 39a,39b, where lengths of the fiber waveguide and the coupling waveguide 40 are both 20 μm and waveguide lengths for absorbing layers 41 are 20 μm too.

Although the scattering of optical power is diminished and the difficulties for a production are reduced by using the above prior arts, good exchange rates, low polarization sensitivity and improved yield for cleaving process are all in lack. Hence, the prior arts do not fulfill users' requests on actual use.

### SUMMARY OF THE INVENTION

The main purpose of the present i n v e n t i o n is to improve a y i e I d of a cleaving process, to lessen difficulties for a production, to diminish scattering of optical power on shifting, and to obtain a high optical responsivity and a low polarization sensitivity.

To achieve the above purpose, the present invention is a waveguide structure having a ladder configuration, comprising a first optical waveguide layer, a second optical waveguide layer and a third optical waveguide layer, where the first optical waveguide layer is a layer of an optical fiber waveguide to collect optical power; the second optical waveguide layer is a layer of a coupling waveguide located away from a cleaving surface between the first optical waveguide layer and the third optical waveguide layer for transferring the position of the optical power into the third optical waveguide layer with the same width of the second optical aveguide layer as that of the first optical waveguide layer to obtain an easy production; and the third optical waveguide layer is an active region having a characteristic of absorbing optical power. Accordingly, a novel waveguide structure having a ladder configuration is obtained.

### BRIEF DESCRIPTIONS OF THE DRAWINGS

The present invention will be better understood from the following detailed descriptions of the preferred embodiments according to the present invention, taken in conjunction with the accompanying drawings, in which

FIG. 1A is a sectional view showing a first preferred embodiment according to the present invention;

FIG. 1B is a sectional view showing a second preferred embodiment;

FIG. 2 is a sectional view showing an application of the first preferred embodiment as a photo detector having a distributed Bragg reflector;

FIG. 3 is a view showing curves of optical power distributions under a TE mode simulated by using a BPM method;

FIG. 4 is a view showing the curves under a TM mode;

FIG. 5 is a view showing distributional curves of total optical power at various cleaving positions under different polarization modes;

FIG. 6 is a view showing the curves with various incident wavelengths;

FIG. 7 is a top view showing an application as a photo detector;

FIG. 8 is a perspective view of a first prior art of ATG;

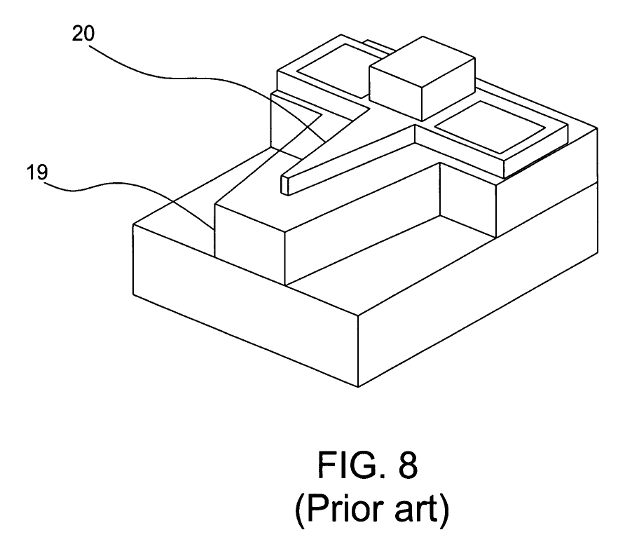

FIG. 9 is a view of a refractive index curve for various epitaxy layer thicknesses;

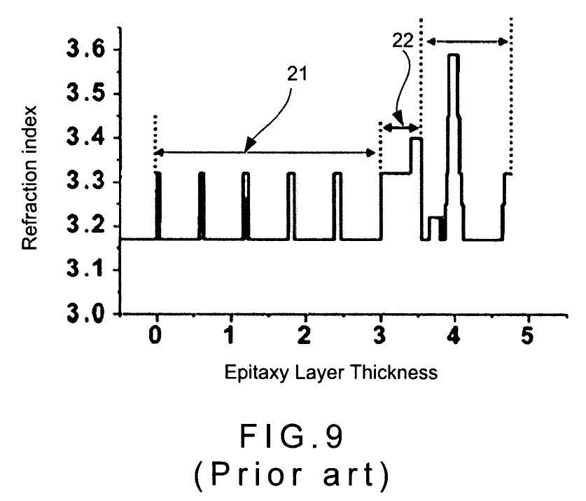

FIG. 10 is a view of distributions of optical power simulated by using the BPM method;

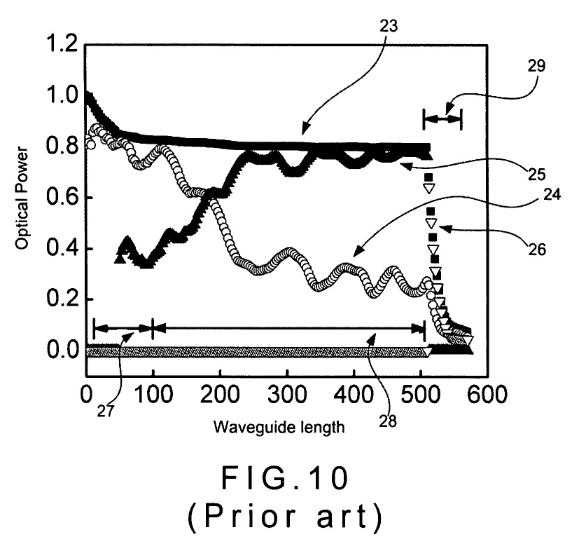

FIG. 11 is a sectional view of a second prior art of SPMG;

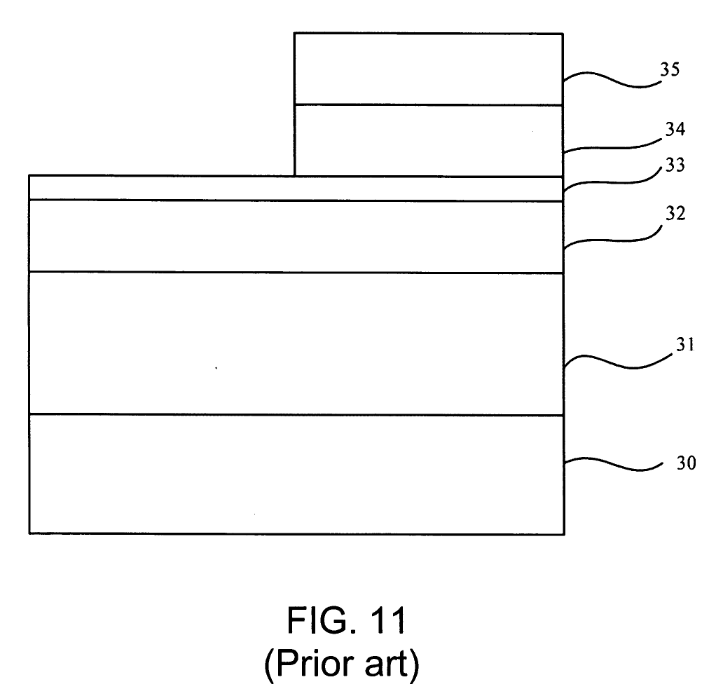

FIG. 12 is a view of the distributions of optical power under a TE mode; and

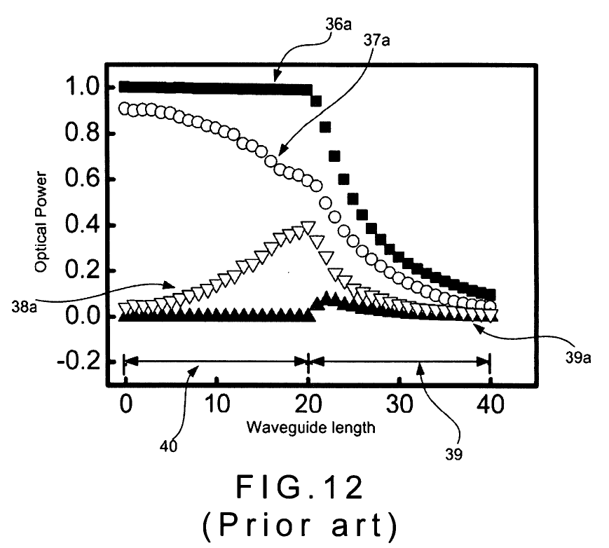

FIG. 13 is a view of the distributions under a TM mode.

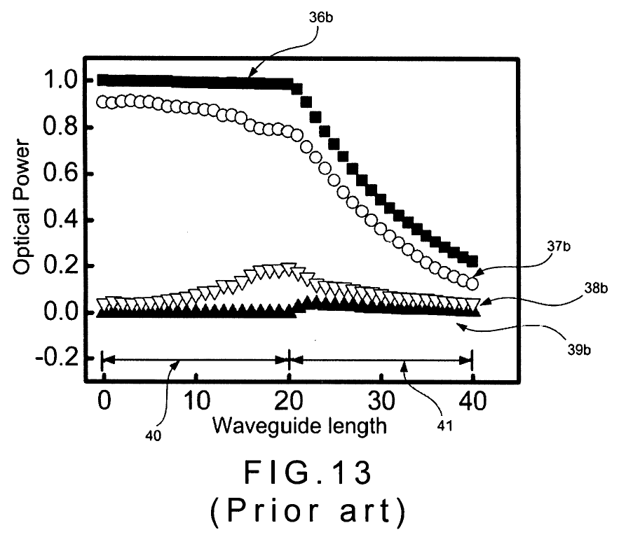

### DESCRIPTION OF THE PREFERRED EMBODIMENT

The following descriptions of the preferred embodiments are provided to understand the features and the structures of the present invention.

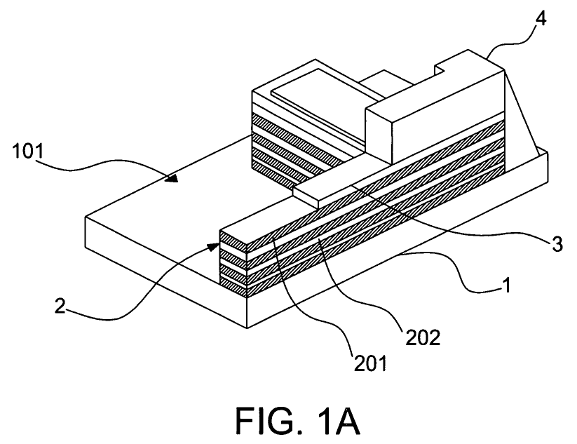

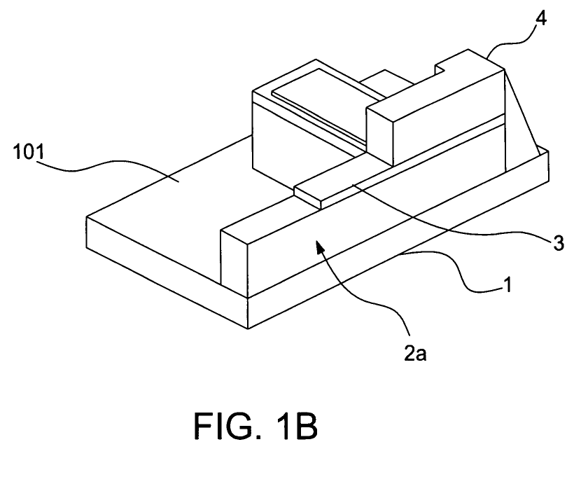

Please refer to FIG. 1A and FIG. 1B, which are sectional views showing a first preferred embodiment and a second preferred embodiment according to the present invention. As shown in the figures, the present invention is a waveguide structure having a ladder configuration, comprising a substrate 1, a first optical waveguide layer 2, a second optical waveguide layer 3 and a third optical waveguide layer 4, where the first optical waveguide layer 2, the second optical waveguide layer 3 and the third optical waveguide layer 4 are stacked on the substrate 1 forming a ladder configuration; the first optical waveguide layer 2 is covered on the substrate 1; the second optical waveguide layer 3 is covered on the first optical waveguide layer 2; and the third optical waveguide layer 4 is covered on the second optical waveguide layer 3. The substrate 1 is a layer of a doped or semi-insulated semiconductor, made of GaAs, InP, GaN, AlN, Si or GaSb. The first optical waveguide layer 2, the second optical waveguide layer 3 and the third optical waveguide layer 4 are each a layer of a compound or a compound alloy, where the compound is GaAs, InP or GaN; and the compound alloy is AlGaN, InGaN, InGaAs, InGaAsP, InAlAs, InAlGaAs, GaAs or AlGaAs. Or, the first optical waveguide layer 2, the second optical waveguide layer 3 and the third optical waveguide layer 4 are each a layer of a column IV element or an alloy of a column IV element, where the column IV element is Si; and the alloy of a column IV element is SiGe.

The first optical waveguide layer 2 is a layer of an optical fiber waveguide for collecting optical power, shaped into a square with a length longer than 160 micrometer (μm) and not longer than a length between 200 μm and 300 μm to provide a high cleaving tolerance. The width of the first optical waveguide layer 2 is around several micrometers for collecting most of the optical power. The first optical waveguide layer 2 is obtained by using a material having a lower refractive index 201 inter-inserted with layers of a material having a higher refractive index 202. The layers of the material having the higher refractive index 202 can grows thicker and thicker from bottom to top; or, the first optical waveguide layer 2a can be a single layer of a material having a slightly higher refractive index than that of the substrate 1 (as shown in FIG. 1B). With the width of the first optical waveguide layer 2,2a, most of the optical power is collected.

The second optical waveguide layer 3 is a layer of a coupling waveguide to transfer the position of the optical power collected by the first optical waveguide layer 2 into the third optical waveguide layer 4. The second optical waveguide layer 3 is deposed between the first optical waveguide layer 2 and the third optical waveguide layer 4 and is located away from the cleaving facet 101 to improve the yield of the cleaving process. The second optical waveguide layer 3 is shaped into a square with a length between 20 μm and 60 μm and a width as wide as that of the first optical waveguide layer 2 for an easy fabrication. The second optical waveguide layer 3 can be a single layer or multi-layers of a material having a higher refractive index. For example, the substrate 1 can be made of InP and the first optical waveguide layer 2 can be made of InGaAsP, where a refractive index is obtained by adjusting the mole fraction of phosphorus. Then, the thickness and the refractive index of the second optical waveguide layer 3 is determined to obtain a better efficiency of shifting.

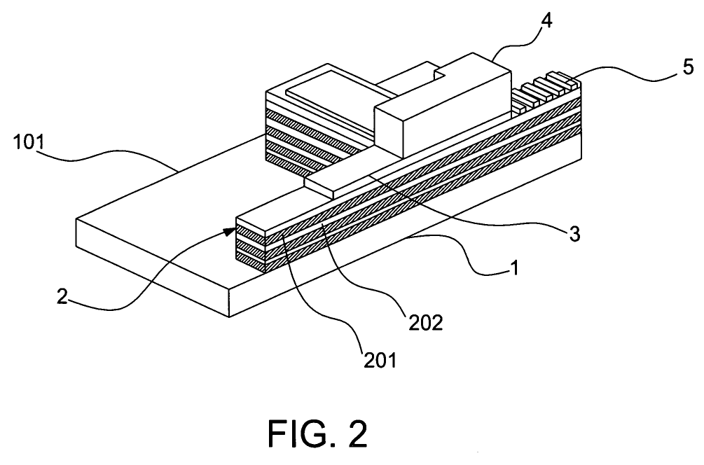

The third optical waveguide layer 4 is an active region having a light-absorbing material; or, can be replaced with a device of a photo detector or a light modulator having a structure of P-doped—undoped—N-doped (P-I-N), where the light-absorbing material is made of a P-doped or undoped material Please refer to FIG. 2, which is a sectional view showing an application of the first preferred embodiment as a photo detector having a distributed Bragg reflector. As shown in the figure, multi-layers of optical reflection films or distributed Bragg reflectors 5 fabricated through a lithography can be grown behind the photo detector. After an absorption of optical power, remaining optical power is reflected by the distributed Bragg reflector 5 to improve the product of the efficiency and the bandwidth. Thus, a novel waveguide structure having a ladder configuration is obtained.

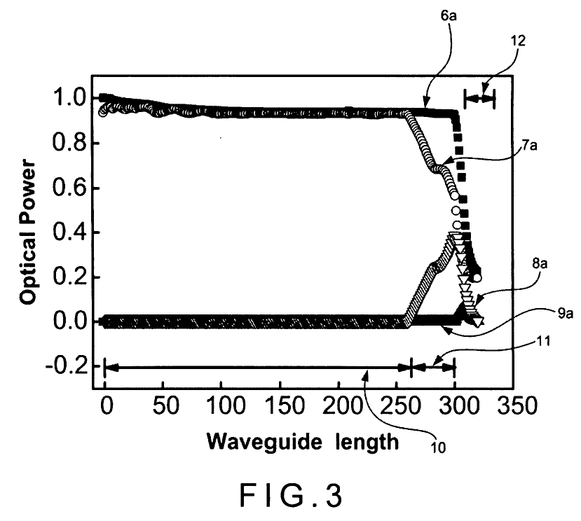

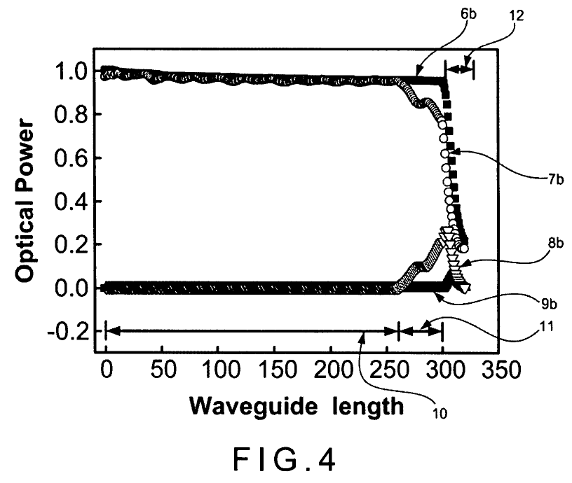

Please refer to FIG. 3 and FIG. 4 which are views showing curves of optical power distributions under a transverse electricwave (TE) mode and under a transverse magneticwave (TM) mode simulated by using a beam propagation method (BPM). As shown in the figures, views showing the distributions of optical power under a TE mode and a TM mode simulated by using a BPM method are obtained. Distribution curves shown in the figures comprise total energy distribution curves 6a,6b and energy distribution curves for optical fiber waveguides 7a,7b, coupling waveguides 8a,8b and waveguides in active regions 9a,9b. The length of a first optical waveguide layer 10 according to the present invention is 260 μm; a second 11, 40 μm; and, a third 12, 20 μm. With such a structure, distributions of optical power under various modes are simulated; and, almost the same absorbing efficiencies are found. Hence, it is known that such a structure is not sensitive to polarization. Furthermore, a high responsivity and a low polarization sensitivity is obtained by precisely adjusting the length and the structure of the coupling waveguide of the second optical waveguide layer 3 with no regard to the cleaving position.

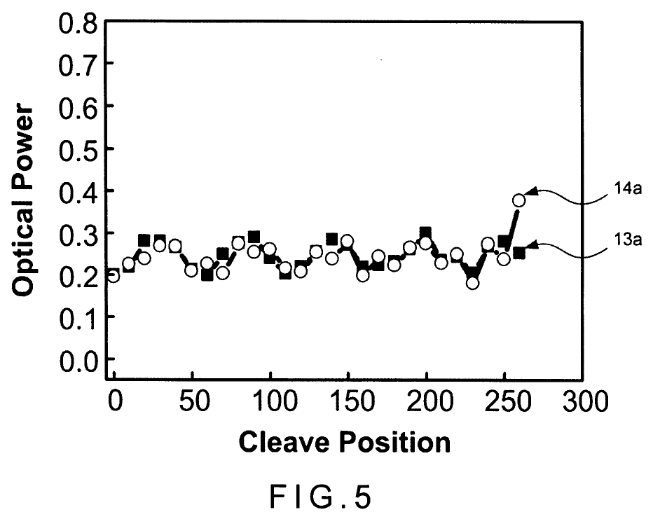

Please refer to FIG. 5, which is a view showing distributional curves of total optical power at various cleaving positions under various modes (TE, TM). As shown in the figure, curves of distributions of total optical power at various cleaving positions under various modes simulated by using the BPM method are obtained. Distributional curves in the figure show total energy distributions under a TE mode 13a and a TM mode 14a. Accordingly, the present invention has a structure with similar cleaving positions and similar related responsivities under various modes.

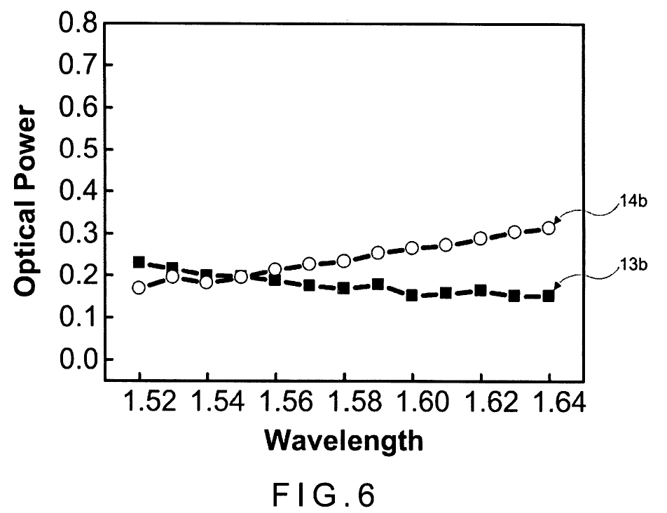

Please refer to FIG. 6, which is a view showing the curves with various incident wavelengths. As shown in the figure, views showing the distributions of optical power with various incident wavelengths under various modes simulated by using the BPM method are obtained. Distribution curves in the figure show total energy distributions under a TE mode 13b and a TM mode 14b. As is shown in the figure, the structure of the present invention has small differences over responsivities for various incident wavelengths under various modes with regard to the changes in the wavelengths; and, so, the shifting efficiency of optical power is improved for being applied to a coarse wave division multiplexing (CWDM) system.

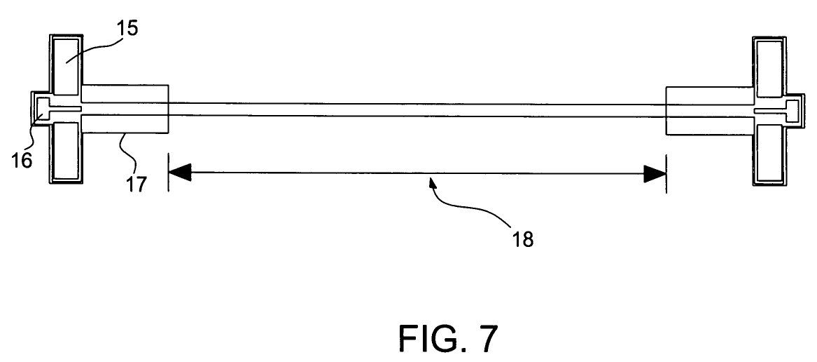

Please refer to FIG. 7, which is a top view showing an application to a photo detector. As shown in the figure, the present invention is applied to a photo detector or a light modulator with a structure of P-doped 15—undoped—N-doped 16. The coupling waveguide of the second optical waveguide layer has an optical square mask 17 to increase an alignment tolerance for a production. The length of the optical fiber waveguide of the first optical waveguide layer is longer to provide; higher cleaving tolerance so that the optical power is steadily transferred at the cleaving position 18 with no loss owing to scattering. The waveguide structure of the present invention can be constructed with a photo detector of a uni-traveling carrier photo detector (UTCPD) or an avalanche photo detector (APD) to obtain a side-illuminating photo detector.

To sum up, the present invention is a waveguide structure having a ladder configuration, where a scattering of optical power is lowered; an alignment tolerance for a production is increased; a sensitivity polarization is lessened; and a yield for a cleaving process is improved.

The preferred embodiments herein disclosed are not intended to unnecessarily limit the scope of the invention. Therefore, simple modifications or variations belonging to the equivalent of the scope of the claims and the instructions disclosed herein for a patent are all within the scope of the present invention.

What is claimed is:

1. A waveguide structure having a ladder configuration, comprising:
a substrate;
a first optical waveguide layer, said first optical waveguide layer covering said substrate, said first optical waveguide layer being a layer of an optical fiber waveguide;
a second optical waveguide layer, said second optical waveguide layer covering said first optical waveguide layer, said second optical waveguide layer being a layer of a coupling waveguide; and
a third optical waveguide layer, said third optical waveguide layer covering said second optical waveguide layer, said third optical waveguide layer being an active region.

2. The waveguide structure according to claim 1,
wherein said substrate is made of a material selected from a group consisting of a doped semiconductor and a semi-insulated semiconductor.

3. The waveguide structure according to claim 1,
wherein said first optical waveguide layer is made of a material selected from a group consisting of
a semiconductor of a compound,
a semiconductor of a compound alloy,
a semiconductor of a column IV element and
a semiconductor of a column IV element alloy.

4. The waveguide structure according to claim 1,
wherein said second optical waveguide layer is made of a material selected from a group consisting of
a semiconductor of a compound,
a semiconductor of a compound alloy,
a semiconductor of a column IV element and
a semiconductor of a column IV element alloy.

5. The waveguide structure according to claim 1,
wherein said third optical waveguide layer is made of a material selected from a group consisting of
a semiconductor of a compound,
a semiconductor of a compound alloy,
a semiconductor of a column IV element and
a semiconductor of a column IV element alloy.

6. The waveguide structure according to claim 1,
wherein said first optical waveguide layer has a square figure.

7. The waveguide structure according to claim 1,
wherein said first optical waveguide layer has a length longer than 160 micrometers (μm).

8. The waveguide structure according to claim 1,
wherein said second optical waveguide layer comprises more than one layer.

9. The waveguide structure according to claim 1,
wherein said second optical waveguide layer has a square figure.

10. The waveguide structure according to claim 1,
wherein said second optical waveguide layer has a length between 20 μm and 60 μm.

11. The waveguide structure according to claim 1,
wherein said third optical waveguide layer has a structure of P-doped—undoped—N-doped; and
wherein said third optical waveguide layer is a device selected from a group consisting of a photo detector and a light modulator.

12. The waveguide structure according to claim 1,
wherein said third optical waveguide layer has a light-absorbing material; and
wherein said light-absorbing material is selected from a group consisting of a P-doped material and an undoped material.

13. The waveguide structure according to claim 1,
wherein said substrate is made of a material selected from a group consisting of GaAs, InP, GaN, AlN, Si and GaSb.

14. The waveguide structure according to claim 3,
wherein said semiconductor of a compound is made of a material selected from a group consisting of GaAs, InP and GaN.

15. The waveguide structure according to claim 3,
wherein said semiconductor of a compound alloy is made of a material selected from a group consisting of AlGaN, InGaN, InGaAs, InGaAsP, InAlAs, InAlGaAs, GaAs and AlGaAs.

16. The waveguide structure according to claim 3,
wherein said column IV element is Si.

17. The waveguide structure according to claim 3,
wherein said column IV element alloy is SiGe.

18. The waveguide structure according to claim 11,
wherein, after an absorption of optical power, remaining optical power is reflected at a rear end of said photo detector by a distributed Bragg reflector; and wherein said distributed Bragg reflector is obtained in a way selected from a group consisting of by growing a multi-layers of optical reflection film and by processing a lithography.
